(19) United States
(12) Patent Application Publication
(10) Pub. No.: US 2014/0255629 A1
(43) Pub. Date: Sep. 11, 2014

(54) USE OF DISPERSIONS BASED ON POLYVINYL ACETATE AS A BARRIER LAYER

(71) Applicant: HENKEL AG & CO.KGAA, Duesseldorf (DE)

(72) Inventors: Hanns Misiak, Haan (DE); Holger Eichelmann, Hilden (DE); Christina Huebner, Langenfeld (DE); Oliver Sommer, Duesseldorf (DE)

(73) Assignee: HENKEL AG & CO.KGAA, Duesseldorf (DE)

(21) Appl. No.: 14/284,973

(22) Filed: May 22, 2014

Related U.S. Application Data
(63) Continuation of application No. PCT/EP2012/073461, filed on Nov. 23, 2012.

(30) Foreign Application Priority Data
Nov. 25, 2011 (DE) 10 2011 087 067.9

(51) Int. Cl. C09D 131/04

(52) U.S. Cl. CPC C09D 131/04
USPC 428/34.2; 524/503; 524/522; 524/43; 524/45; 524/521; 524/29; 428/319.3; 428/311.11

(57) ABSTRACT

The invention relates to the use of aqueous dispersions containing at least 50 wt % (in relation to the solid body) of polyvinyl acetate copolymers A and at least one polymer B which is different from said latter and which comprises hydroxy and/or ionic groups, for producing a barrier layer on film-shaped or flat substrates.

The invention relates to the use of aqueous dispersions based on polyvinyl acetate for the production of a coating on film substrates so as to decrease the diffusion of oil-containing substances. The invention further relates to packaging for use with foodstuffs and medical products, wherein the packaging possesses a diffusion-decreasing coating based on polyvinyl acetate.

Polyvinyl acetate dispersions (PVAc dispersions) are generally known. Polyvinyl acetate dispersions are employed in various compositions, for example as an adhesive. It is known, for example, to produce an aqueous PVAc dispersion and to coat it onto the surface of a substrate. This is subsequently adhesively bonded with a second identical or different substrate. After drying the adhesive layer, a sub-composite of both substrates is thus produced. This application can be employed for various substrates, for example also for paper, wood or other substrates.

WO 2009/134538 A1 describes an aqueous coating composition as a barrier layer that comprises a polymeric binder and amine stabilizers. Furthermore, the composition should comprise fillers in particulate form, for example layered particles such as kaolin, calcium carbonate, titanium dioxide, aluminum oxide hydrate and others. Various polymers are described which may be employed in the dispersion, inter alia also polyvinyl acetate. As a test for describing the barrier effect, the oxygen permeation rate through a coated and an uncoated substrate was determined. The decrease in the permeation rate was determined in connection with the pigment-containing dispersion.

EP 1 365 060 A2 describes water-based, hydrophobic barrier coating compositions. They contain polyvinyl acetate dispersions or ethylene vinyl acetate emulsions together with a mixture of paraffin waxes. Non-wovens, textiles or similar substrates are described as the substrate.

Putrescible fiber-reinforced films are known from DE 4238770 A1. They consist of a self-crosslinking synthetic resin dispersion of a vinyl acetate-ethylene copolymer coated onto a coating substrate. Fine-grained pigments can be added to the synthetic resin dispersion so as to control the barrier effect toward water vapor and exhaust gas. A barrier effect against hydrocarbons was not mentioned.

DE 202010005911 U1 discloses completely biodegradable multi-ply films that possess, in addition to a layer of adhesion promoter (a), at least one preferably internal, completely biodegradable barrier layer (b). The barrier layer can be designed as a gas barrier layer, water vapor barrier layer, oil barrier layer or barrier layer against fragrances and/or aromas and must be produced from at least one completely biodegradable polymer. At least partially saponified polyvinyl acetates that have a saponification degree of at least 50 mol %, and ethylene-vinyl alcohol copolymers that have an ethylene content of maximum 20 mol % were cited as the preferred polymers. The multi-ply films can be manufactured by any production process, wherein, solely extrusion and co-extrusion were cited concretely. The coating of a film substrate with an aqueous dispersion was not cited.

A process for packaging foodstuffs and other perishable goods is known from CH 329738 A, wherein a film is deposited directly onto the goods to be packaged or onto an intermediate under layer, said film being obtained by using a dispersion that comprises a synthetic resin and a hydrophilic waxy substance, e.g. lanette wax or beeswax. The latter serves to absorb moisture from the surroundings and is intended to prevent the coating being affected by this moisture. The problem associated with the diffusion of oily substances through film substrates was not raised.

CH 415446 A describes a wrapping and packaging material with a preserving effect and a process for its manufacture. Therein, 0.5 to 20 g calcium sorbate per m² surface area of the wrapping and packaging material are fixed thereon by means of a carrier material. The carrier material can be polymers of the most varied type, inter alia polyvinyl acetate or its copolymers. The formation of barrier coatings was not cited.

The prior art does not describe that specific binders can easily prevent low amounts of oily substances from diffusing through thin substrates.

It is generally known that various types of packaging can be employed in the food industry. They can be manufactured on the basis of polymer films, paper, cardboard or corresponding composite materials. These substrates are usually printed on one side. Various print colors are known for this. However, these print colors, when manufactured, usually contain oil or oily substances in addition to pigments and/or dyes. If the corresponding print color is printed onto a substrate, then optionally the color may also be chemically bound. However, auxiliaries such as the abovementioned oils or similar compounds which are present, remain intact in small quantities in the printed image and the underlying substrate. It is known that these oily substances can migrate through various substrates. When packaging is manufactured from recycled paper materials it is frequently the case that not only the surface but also the whole substrate is contaminated with such substances. Such substances are often referred to by the terms MOSH (mineral oil saturated hydrocarbons) and MOAH (mineral oil aromatic hydrocarbons).

These substances are preferably not comprised in the packaged materials (contained products). Foodstuffs or medical products, for example, should not be contaminated with oil or oil-containing substances. Otherwise, the taste or odor of the packaged goods may change, changes in the composition may occur, and the thus contaminated products may even possibly involve health risks. In this regard even minor amounts may have negative repercussions.

For this reason various attempts have already been undertaken to avoid such oily constituents that are capable of diffusing and migrating. It is of course possible to choose dyes that do not contain these constituents in their composition. However, this limits the choice of print colors; moreover they often have inferior application properties. Furthermore, it is possible to use certain film compositions that essentially prevent any migration or that do not contain such substances. This can be achieved by specific polymers, films or by metal foils. However, these types of packaging are expensive and require additional processing steps.

Therefore, the object of the present invention is to provide aqueous dispersions as coating agents for substrate surfaces, wherein the coatings are located between the packaged goods and an applied printed image, and as a barrier layer should decrease the migration of oily substances. A cost-effective and rapid processing should also be enabled, in particular these coatings should be suitable for substrates made of paper, cardboard or similar naturally occurring products.

The object is achieved by using aqueous dispersions comprising at least 50 wt % (based on the solids content) of at least one polyvinyl acetate copolymer A and at least one polymer B that differs from the latter, wherein polymer B possesses hydroxy and/or ionic groups, as a barrier coating on film substrates so as to prevent any diffusion of oily constituents.

In the context of the present invention, solids are understood to mean the sum of all constituents of the dispersion with the exception of the water. These constituents generally concern solid materials that are dispersed or dissolved in the water. However, the constituents can also concern liquid substances, generally substances of low volatility. These are also counted as solids.

Furthermore, the subject matter of the invention is packaging made of film substrates which, on one of the sides facing towards the inside of the packaging, has a coating for preventing the diffusion of oily constituents, said coating being manufactured by applying aqueous dispersions, comprising at least 50 wt % (based on the solids content) of at least one polyvinyl acetate copolymer A and at least one polymer B that differs from the latter, wherein polymer B possesses hydroxy and/or ionic groups.

The known flexible, flat substrates and carrier materials which are employed for example in the packaging industry are suitable substrates. In this regard, single or multi-ply substrates come into consideration, for example polymer films of polyethylene, polypropylene, polyester, paper substrates, cardboard or similar substrates of composite materials. These kinds of substrate are known; they may have a layer thickness of 50 to 1000 μm. The appropriate substrates are usually provided with a printed image on one side, the external side. Additional coatings may also be coated on this external side. The inner side of the substrate can be directly turned toward the packaged goods; however still other layers may also be found on the carrier material.

Such film substrates and processes for their manufacture are known to the person skilled in the art. They can be produced and immediately further processed. However, they can also be manufactured as a partially finished product and only further processed into the final form, for example packaging, by the client.

The film substrates are preferably porous substrates, in particular paper or cardboard.

The inventively employed aqueous dispersions comprise at least 50 wt % (based on the solids content of the dispersion) of at least one polyvinyl acetate copolymer A. The indications of quantities refer here to the total quantity of all the comprised polyvinyl acetate copolymers. The amount of polyvinyl acetate copolymers A is preferably at least 60 wt %, particularly preferably 60 to 99 wt %, quite particularly preferably 65 to 98 wt % (each based on the solids content).

In principle, aqueous polyvinyl acetate copolymer dispersions are known to the person skilled in the art. In particular they concern copolymers based on monomers reacted by radical emulsion polymerization or suspension polymerization. In this invention, the term dispersion is also intended to include emulsions, suspensions or aqueous solutions.

According to the invention, polyvinyl acetate copolymers are understood to mean those copolymers that comprise at least 80 mol % of structural units that are directly obtained by the polymerization of vinyl acetate, and comprise at least one additional structural unit (comonomer). Preferred polyvinyl acetate copolymers comprise at least 85 mol %, preferably at least 87 mol % of structural units that are directly obtained by the polymerization of vinyl acetate.

The additional structural units result from the incorporation of monomers other than vinyl acetate or from the chemical modification, especially hydrolysis, of a part of the structural units that are directly obtained by the polymerization of vinyl acetate.

Other useable monomers can be other vinyl esters, for example esters of vinyl alcohol and C3 to C6 monocarboxylic acids, for example vinyl hexanoate, vinyl propionate and/or vinyl n-butyrate. Amounts of polymerizable monomers can also be used that carry functional groups that can be converted to anionic groups, for example carboxyl groups, amounts of non-polar copolymerizable monomers, such as aromatic monomers or unsaturated carboxylic acid esters, amounts of monomers that carry polar groups and optionally minor amounts of polymerizable compounds containing more than one double bond.

Various copolymerizable monomers may be employed. Preferably however, neither halogenated monomers nor ethylene should be used, nor monomers with functional groups that can react with one another and which could subsequently crosslink with one another in storage or during the application.

In addition, copolymerizable monomers that comprise acid groups as the additional functional group may be optionally comprised. They may be inorganic acid groups, such as sulfonic acid, phosphoric acid, boronic acid or phosphonic acid groups, or preferably carboxylic acid groups. Examples of these are vinylphenyl sulfonic acid, vinyl sulfonic acid, vinyl phosphoric acid or vinylphenyl phosphonic acid. In particular, α,β-unsaturated C3 to C9 mono or dicarboxylic acids may be comprised, especially C3 to C5. They are particularly preferably acrylic acid, methacrylic acid, itaconic acid, crotonic acid and/or maleic acid, sorbic acid, fumaric Acid or their half esters with C1 to C4 alcohols. The corresponding carboxylic acid anhydrides can also be employed.

Moreover, inventively suitable copolymers can additionally comprise non-polar monomers, i.e. these should not possess any polar groups. Examples of these are esters of α,β-ethylenically unsaturated C2 to C5 mono or dicarboxylic acids with C1 to C12 linear or branched alcohols, such as for example the methyl, ethyl, n-butyl, iso-butyl and 2-ethylhexyl esters of acrylic acid and methacrylic acid, the methyl, ethyl and propyl esters of crotonic acid, the dimethyl or di-n-butyl esters of maleic acid and fumaric acid. Further, vinyl esters of long chain linear or branched monocarboxylic acids can be comprised as the non-polar monomer. Examples of these are vinyl esters of C7 to C18 monocarboxylic acids, such as stearic acid, lauric acid or versatic acid.

Likewise it is not excluded that the polymers are Weakly crosslinked through branching units or have a branched structure. This can be achieved by means of minor amounts of multi-functional monomers. In this case they can be di- or polyfunctional monomers. These polyfunctional monomers afford branching or crosslinking within the polymer particles. The swelling behavior or the viscosity of the dispersion can be influenced in this manner. The copolymers preferably have a high molecular weight. The molecular weight is preferably greater than 250 000 g/mol (M_{w}, measured by GPC against polystyrene standards).

Those polyvinyl acetate copolymers are preferably used which, in addition to structural units that are directly obtained by the polymerization of vinyl acetate, comprise only one structural unit as the additional structural unit which can be obtained by partial hydrolysis of the vinyl acetate structural units. In other words, the preferred polyvinyl acetate copolymers are partially hydrolyzed polyvinyl acetate copolymers. The degree of hydrolysis is maximum 20 mol %, preferably maximum 15 mol % and particularly preferably maximum 13 mol %. Appropriate polyvinyl acetate copolymers are commercially available. The polyvinyl acetate copolymers that are preferably employed are those marketed under the names Adhesin A6058 and Wormalit PM 5208 by Henkel AG & Co KGaA.

Protective colloids are optionally employed to produce the polyvinyl acetate copolymers. Anionic or non-ionic substances can be employed as the protective colloid for manufacturing the polymer dispersion. Examples of these are naturally occurring polymers, such as starch ethers and/or cellulose ethers or their derivatives, e.g. modified by oxidation, esterification, etherification, acidic degradation, especially hydroxyalkyl ether starches, hydroxyalkyl celluloses, carboxyalkyl celluloses, carboxyalkyl ether starches; dextrins or hydroxyalkyl dextrins. They can be used singly or in a mixture.

The protective colloids should be anionic or neutral, optionally even after neutralization. These products are commercially available and can be selected according to their properties by a person skilled in the art.

Suitable polyvinyl acetate copolymer dispersions can be manufactured by processes known per se in aqueous solution by radical polymerization in the presence of protective colloids or surfactants. Processes for manufacturing the copolymers are known to the person skilled in the art. Moreover, such dispersions are commercially available in different compositions with various molecular weights.

The inventively employed aqueous dispersions comprise, in addition to at least 50 wt % (based on the solids content) of at least one polyvinyl acetate copolymer A, also at least one polymer B that differs from the latter, wherein polymer B possesses hydroxy and/or ionic groups. Due to the hydroxy and/or ionic groups comprised in the polymer, polymer B has a strongly polar character. It was surprisingly found that the barrier properties were significantly improved by adding these polar copolymers in comparison with coatings based on pure polyvinyl acetate polymers.

Polymer B is preferably selected from polyvinyl alcohols, polyelectrolytes, oligo and polysaccharides and their derivatives, such as e.g. cellulose derivatives, chitosan derivatives and their mixtures.

Commercially available products can be used as the polyvinyl alcohols. They generally have a degree of hydrolysis of 98 to 99 mol % or 87-89 mol %. Polyvinyl alcohols that have a degree of hydrolysis between 70 and 99 wt %, preferably 85 to 99 wt %, are preferably employed.

Preferred polyelectrolytes, which also include polyampholytes, are selected from gum arabic, copolymers of vinyl pyrrolidone with at least one monomer that comprises a quaternary ammonium group, and salts of polyacrylic acids, polymethacrylic acids, poly(acrylic acid-co-acroleins), polyalginic acids, pectins, polyphosphoric acids, polyvinylphosphonic acids, polyvinylsulfonic acids, polyvinylsulfuric acids and poly(styrene-4-sulfonic acids).

The cellulose derivatives that are employed are preferably hydroxymethyl celluloses, hydroxyethyl celluloses, hydroxypropyl celluloses, hydroxypropylmethyl celluloses, cellulose carbamates and/or carboxymethyl celluloses.

Preferred chitosan derivatives are selected from chitosan pyroglutamate, chitosan lactate and hydroxypropyl chitosan.

From the group of the poly and oligosaccharides which also have somewhat of a polyelectrolyte character, as they can comprise at least scattered carboxylic or carboxylate groups (in salt form), consequently the following are concerned: dextrans, agarose, galactanes, carrageen, tara gum, locust bean flour, xanthan, galactomannans, guar flour, karaya gum, secaline, gliadine, traganthe, glycosamino glycanes.

Particularly preferred polymers B are selected from polyvinyl alcohols, poly(sodium acrylates), poly(sodium styrene sulfonates), carboxymethyl celluloses, hydroxypropylmethyl celluloses and their mixtures.

The total amount of polymer B (based on the solids content) is preferably 1 to 50 wt %, particularly preferably 1 to 40 wt % and quite particularly preferably 2 to 35 wt %.

Furthermore, the inventively employed dispersions can comprise up to 49 wt % (based on the solids content) of auxiliaries, for example surfactants, wetting agents, defoamers, stabilizers, pigments, colorants, fillers, antioxidants, photostabilizers, biocides, fluorescence markers, buffers, pH adjustors, thickeners, thixotropes and other inert polymers. However, the total amount of auxiliaries is preferably 40 wt % at most, preferably 30 wt % at most, particularly preferably 20 wt % at most, quite particularly preferably 10 wt % at most, especially preferably 5 wt % at most and more preferably 1 wt % at most (each based on the solids content). Preferably, however, no waxes and/or solvents are comprised.

In this regard, the auxiliaries can already be incorporated in the course of manufacturing the polyvinyl acetate copolymer A and/or the polymer B, in so far as they do not interfere with the polymerization. Auxiliaries may also be added in the course of manufacturing the dispersion employed as the coating agent.

The suitable dispersion can comprise a surface active substance. These substances are understood to mean those that reduce the interfacial tension to water, such as defoamers, surfactants and wetting agents. They can be comprised in addition to the abovementioned protective colloids. Such materials generally comprise hydrophilic and hydrophobic groups. A part of the surface active agents can be added prior to the polymerization or they are initially incorporated into the dispersion. They provide wetting, avoid foaming as well as stabilizing the fractions of monomers, polymers or additives, optionally also pigments or fillers that by themselves are water-insoluble. Anionic, non-ionic, ampholytic surfactants or their mixtures can be comprised. Examples of these are anionic surfactants, such as alkyl sulfates, alkyl ether sulfates, alkylaryl ether sulfates, fatty alcohol sulfonates, alkyl sulfonates, alkylaryl sulfonates; esters and half esters of sulfosuccinic acid, which can be optionally ethoxylated; alkali metal and ammonium salts of carboxylic acids; ampholytic surfactants, such as long chain substituted amino acids or betaines; non-ionic surfactants, such as alkyl, alkylaryl, fatty alcohol polyglycol ethers; ethylene oxide/propylene oxide (EO/PO) block copolymers, (EO/PO) fatty alcohols, and (EO/PO) alkylphenol adducts, natural products and their derivatives, polar group-containing linear organo(poly)siloxanes.

In a preferred embodiment of the invention, the dispersion comprises at least one anionic or one non-ionic surfactant. According to the invention, the content is preferably kept low. The inventively employed dispersion can comprise such surface active substances in an amount of 0 to about 5.0 wt %, in particular 0.2 to 2.5 wt % (based on the solids content).

Inert polymers may be comprised. These differ from the polyvinyl acetate copolymers A and the polar polymers B. Exemplary suitable inert polymers are polyvinyl pyrrolidone or polycarboxylic acids, such as poly(meth)acrylic acids.

Benzoates, amidic substances and hydroxybenzoic acid esters or other suitable commercial biocides can be advantageously added as the preservatives in amounts of 0.2 to 1 wt %. The inventive dispersion can comprise up to 2 wt %, preferably 0.1 to 1 wt % of UV stabilizers as further additives. The so-called HALS compounds are particularly suitable as the UV stabilizers.

The inventively suitable dispersion can further comprise fractions of plasticizers or tackifier resins for example, wherein paraffin-like substances are less suitable. The amount, based on the total coating agent, should be less than 10 wt %, preferably less than 5 wt %, particularly preferably less than 1 wt % and quite particularly preferably less than 0.1 wt %. In particular, the amount should be low enough, such that after drying, resulting coatings are tack-free.

In one embodiment, the inventively employed coating agent can also comprise pigments and/or fillers. These can be blended into the dispersion at a later stage, or preferably the polymerization takes place in the presence. of the fillers. Organic or inorganic fillers with a particle size of about 0.1 to about 20 μm, for example 0.5 to 10 μm, are particularly suitable. Fillers are also understood to include pigments, in so far as these are insoluble in the aqueous phase. In the context of the present invention, exemplary suitable pigments/fillers are inorganic substances that are inert under the storage conditions. Exemplary suitable inorganic materials are layered silicates, quartz flour, silica gel, barium sulfate, metal oxides, zeolites, calcium minerals, aluminum oxide or zinc oxide. The cited inorganic materials can be employed singly or in a mixture. The amount of the filers in the coating agents according to the invention can be 0 to 49 wt % (based on the solids content).

The solids content of the inventively employed aqueous dispersion should be between 30 and 70 wt %, especially from 35 to 60 wt %. The composition is preferably free of substances that are not food-approved.

The dispersions should preferably be free of organic solvents, i.e. only minor amounts of less than 0.5 wt % should be comprised.

The pH (23° C.) of the inventively employed polymer dispersion can vary over a broad range. Preferably however, the pH (23° C.) is between 3.5 and 9.0, particularly preferably between 5.5 and 8.0 and especially between 6.5 and 8.0. In this regard, if the pH is adjusted by the addition of neutralizers, then a change in the form of the polymer may possibly occur, for example a polymer from the dispersion form can convert into a soluble form, thereby modifying the rheological properties.

The viscosity of the inventively employed aqueous dispersion at a temperature of 20 to 40° C. should be 10 to 10 000 mPas, especially more than 100 mPas (cone-plate measurement, DIN 53229). These dispersions are stable and storable. The viscosity of the finished coating agent at 25° C. is preferably less than 8000 mPas, in particular less than 5000 mPas. The viscosity can be adjusted in such a way that the coating behavior, behavior toward an optionally employed coating device and film formation are facilitated.

The suitable aqueous dispersions can be manufactured by mixing the components in a manner known per se. It is advisable here to first of all manufacture a polymer dispersion. The viscosity and dissolution behavior of the dispersion can then be adjusted by neutralization of the anionic groups.

Processes for coating the aqueous dispersion onto the film substrates are generally known. An appropriate dispersion can be applied for example by spraying, rolling, printing, coating with a doctor blade or similar processes. Here, the liquid coating is applied, it can flow and the water content of the coating is evaporated. This can be accelerated for example by additional measures, such as passing gases, for example air, over the coating or by elevating the temperature, for example with warm air or by IR irradiation. With porous substrates, a part of the water is also absorbed by the substrate.

Such coating processes are known to the person skilled in the art. Tack-free surfaces are obtained after coating. They can be stored, although it is also possible to further process them directly. The substrates, even when rolled or stacked, do not adhere to one another after the coating has been dried.

For example, the coated substrates can be provided with other layers, for example by lamination or by coating. In this regard, the side of the substrate that was coated with the aqueous dispersion can be laminated or further coated, for example with polyethylene films, polyester films or sealing layers. However, it is likewise possible to apply additional coatings or additional layers on the side of the substrate facing away from the coating.

Inventively it is only required that a continuous coating with an inventively employed dispersion was manufactured on the side of the composite film which faces inwards. The layer thickness (dry) should be from 2 to 100 g/m², for example from 3 to 50 g/m², preferably from 3 to 40 g/m².

Printing processes for depositing printed images on the side located opposite the coating can also be carried out in the further processing procedures. This can be carried out immediately before the further finishing; however, the manufacturer of these film substrates may also carry out appropriate printing processes.

Packaging can be manufactured from the inventively coated film substrates. Here, the delivered substrates, for example in the form of a reel, are cut to shape and shaped to form packaging, optionally stuck together or adhesively bonded to substrates of another composition. For example, packaging for foodstuffs, oil-containing products, odor-intensive products or similar goods can be manufactured from the inventively coated substrates. In this regard it is inventively advantageous when the inventively coated side of the film substrate faces the packaged goods. The printed images, for example, can be applied on the exterior of the film.

The inventively manufactured coatings prevent diffusion or migration of oily substances through the carrier substrate or out of the carrier substrate. In the context of this invention, oily compounds are understood to mean solid, liquid or even volatile substances, which possess nonpolar properties. They particularly concern hydrocarbon-based substances, for example aliphatic, cycloaliphatic, aromatic or naphthenic oils (MOSH, MOAH) or also plasticizers. In this regard, they can concern oils and derivatives.

Furthermore, minor amounts of the known organic oils are also retained by the coating. They concern oils and fats, which are present in natural products, for example non-drying or semi-drying hydrocarbon-based oils.

A third class of compounds that are prevented from diffusing or migrating are low molecular weight hydrocarbon-based substances that occur as an odorous substance or are comprised in gasoline and diesel fuels. Examples of such compounds are terpenes or derivatives, such as limonene or naphthalene.

Those hydrocarbons that are especially prevented from diffusing by an inventively manufactured coating are the linear or cyclic hydrocarbons that contain more than 10 carbon atoms, in particular also more than 12 carbon atoms. These are usually liquid or solid, but can migrate through different substrates.

A substrate that is provided with a coating according to the invention reduces or prevents oily substances from migrating through the substrate. In this way substances that are on the external surface of the substrate are kept away from the interior of the package. Another type of use prevents contaminants that are generally present in the carrier substrates from migrating. Recycled paper for example, may also comprise residues of printing ink solvents. Such contaminants can be prevented from diffusing. Another type of use prevents odor-intensive substances from migrating through packaging. For such articles it is desirable that fragrant ingredients do not escape through the packaging to the outside.

The multi-ply substrates can additionally comprise further layers that perform other functions, for example as a carrier substrate for improving the tear strength, as a moisture barrier, as a barrier against specific gases. Other layers can be decorative or serve as an adhesive layer.

In summary, packaging can be manufactured from the described coated film substrates to afford a simple packaging for everyday consumer items. This protects the contents from the external packaging layers or from the environment. Migration or diffusion of oily substances through the coated substrate is reduced. The invention makes available a simple composition in order to manufacture corresponding coatings.

### EXAMPLES

The invention is illustrated below in more detail by means of examples. Percentages, if not otherwise stated, mean weight percent.

### Example 1

A polyvinyl acetate dispersion was employed that is commercially available under the name Adhesin A6058 from Henkel AG & Co. KGaA. It has a solids content of 55%. A minor portion of the acetate groups is hydrolysed. 0.5% of a non-ionic emulsifier is comprised.

Polyvinyl alcohol (1.5%, M_{w} 190 000 g/mol) was added to the dispersion (66.5%) and blended with water (32%).

Solids content: 38.5%

Viscosity: 200 mPas

### Example 2

The same ingredients were employed as in Example 1 but the quantities were varied. PVAc dispersion (70%), polyvinyl alcohol (4.5%) and water (25.5%).

SC: 43%

Viscosity: 500 mPas

### Example 3

A polyvinyl acetate dispersion was employed that is commercially available under the name Wormalit PM 5208 (solids content 55%) from Henkel AG & Co. KGaA. PVAc dispersion (90%), polyvinyl alcohol (1.5%) and water (8.5%).

SC: 51%

Viscosity: 8000 mPas

### Example 4

Polyvinyl alcohol (2.76%, M_{w} 190 000 g/mol) was added to a polyvinyl acetate dispersion (62.5%) that is commercially available under the name Adhesin A6058 from Henkel AG & Co. KGaA, and blended with water (34.74%).

Solids content: 37.1%

pH (23° C.): 4

### Example 5

Example 4 was repeated, but the resulting dispersion was adjusted with NaOH to a pH (23° C.) of 7.

Solids content: 37.1%

pH (23° C.): 7

### Example 6

Poly(sodium acrylate) (17.5%) was added to a polyvinyl acetate dispersion (62.5%) that is commercially available under the name Adhesin A6058 from Henkel AG & Co. KGaA, and blended with water (20%).

Solids content: 51.9%

### Example 7

Poly(sodium acrylate) (15%) and polyvinyl alcohol (2.75%, M_{w} 190 000 g/mol) were added to a polyvinyl acetate dispersion (62.5%) that is commercially available under the name Adhesin A6058 from Henkel AG & Co. KGaA, and blended with water (19.75%). The resulting dispersion was adjusted with NaOH to a pH (23° C.) of 7.

Solids content: 52.1%

pH (23° C.): 7

### Example 8

Hydroxypropylmethyl cellulose (0.9%) was added to a polyvinyl acetate dispersion (62.5%) that is commercially available under the name Adhesin A6058 from Henkel AG & Co. KGaA, and blended with water (36.6%).

Solids content: 35.3%

### Example 9

Poly(sodium styrene sulfonate) (5%) was added to a polyvinyl acetate dispersion (65%) that is commercially available under the name Adhesin A6058 from Henkel AG & Co. KGaA, and blended with water (30%).

Solids content: 40.8%

### Example 10

Carboxymethyl cellulose, sodium salt (1.8%) was added to a polyvinyl acetate dispersion (65%) that is commercially available under the name Adhesin A6058 from Henkel AG & Co. KGaA, and blended with water (33.2%).

Solids content: 37.6%

### Comparative Example 1

A pure polyvinyl acetate dispersion (Adhesin A6058) was employed.

SC: 55%

Viscosity: 8500 mPas

### Comparative Example 2

EVA dispersion (Vinamul 3161, Celanese) SC: 59%

### Comparative Example 3

Polyacrylate-co-acrylonitrile (Acronal 81 D, BASF) SC: 60%

### Comparative Example 4

Polyester urethane (Dispercoll KA 8755, Bayer) SC: 40%

The dispersions employed in the comparative examples were commercially available dispersions.

Experimental Method:

Each dispersion according to the examples 1 to 10 and to the comparative examples 1 to 4 was coated onto a substrate with a doctor blade or with an adjustable doctor blade. The substrate was in each case a 190 g/m² cardboard substrate (HIG Company).

Each coating was dried for 24 hours at 25° C.

The layer thickness was ca. 20 inn (dry).

A cap with a round opening of 4.2 cm was screwed onto a 100 ml wide-necked glass flask. The opening was covered with the respective coated substrate and sealed at the edge with the cap. The coated surface was facing outward. Into the glass flask were added either limonene (50 mg on cotton; simulating aliphatic hydrocarbons/MOSHs) or naphthalene (50 mg; simulating aromatic hydrocarbons/MOAHs) as the test substance. The flasks were each packed in a resealable plastic bag. They were stored at 25° C. Odor samples were taken from the bag after various times in order to determine whether the strongly smelling test substance had migrated through the coated substrate. The test substances are strongly smelling, olfactorily easily and clearly detectable substances. The results are presented in Table 1.

TABLE 1

| | Limonene | | Naphthalene | |
|---|---|---|---|---|
| | clearly | Limonene | clearly | Naphthalene |
| | detectable | first signs | detectable | first signs |
| Example 1 | 24 h | 3 h | 24 h | 24 h |
| Example 2 | >24 h | 4 h | >24 h | 24 h |
| Example 3 | 24 h | 4 h | 24 h | 6 h |
| Example 4 | >24 h | 3 h | >24 h | 7 h |
| Example 5 | >24 h | 5 h | >24 h | >24 h |
| Example 6 | 25 h | 3 h | 26 h | 24 h |
| Example 7 | 25 h | 3 h | 26 h | 24 h |
| Example 8 | 25 h | 19 h | 26 h | 25 h |
| Example 9 | >24 h | 20 h | >70 h | >24 h |
| Example 10 | >70 h | 20 h | >70 h | >24 h |
| Comparative | 24 h | 3 h | 24 h | 6 h |
| example 1 | | | | |
| Comparative | 2 h | 2 h | 2 h | 2 h |
| example 2 | | | | |
| Comparative | 2 h | 2 h | 6 h | 5 h |
| example 3 | | | | |
| Comparative | 5 h | 5 h | 2 h | 2 h |
| example 4 | | | | |

It was found that by the use of a pure polyvinyl acetate dispersion (comparative example 1) low molecular weight exemplary substances are already retained longer than by other coatings (comparative examples 2 to 4). Surprisingly, the barrier properties can be again significantly increased by adding an additional polar polymer to an aqueous polyvinyl acetate dispersion (examples 1 to 10).

In practice, packaging based on coated cardboard substrates is often manufactured by folding the corresponding flat substrates. This can damage the coating. In order to test the behavior of inventively coated substrates under these conditions, substrates were investigated according to the above procedure, wherein after production each coating was folded 180° and opened out again. The results are presented in Table 2.

TABLE 2

| | Limonene | | Naphthalene | |
|---|---|---|---|---|
| | clearly | Limonene | clearly | Naphthalene |
| | detectable | first signs | detectable | first signs |
| Example 1 | 24 h | 3 h | 24 h | 24 h |
| Example 2 | 24 h | 4 h | 24 h | 6 h |
| Comparative | 2 h | 2 h | 2 h | 2 h |
| example 1 | | | | |

It is shown that under these conditions, when using a pure polyvinyl acetate dispersion (comparative example 1), the low molecular weight exemplary substances are only insufficiently retained. By using a combination of polyvinyl acetate and polyvinyl alcohol (examples 1 and 2) the barrier properties are still pronounced in spite of the folding.

1. An aqueous dispersion for a barrier coating comprising:
(A) at least 50 wt %, based on the total solids content of the aqueous dispersion, of a polyvinyl acetate copolymer A;
(B) a polymer B that contains hydroxy and/or ionic groups
wherein the copolymer A is different from polymer B.

2. (canceled)

3. The aqueous dispersion according to claim 1, wherein polymer B is selected from polyvinyl alcohols, polyelectrolytes, cellulose derivatives, chitosan derivatives and mixtures thereof.

4. The aqueous dispersion according to claim 3, wherein the polymer B is the polyvinyl alcohols, having a hydrolysis degree between 70 and 99 wt %.

5. The aqueous dispersion according to claim 3, wherein the polymer B is the polyelectrolytes selected from polyampholytes, gum arabic, copolymers of vinyl pyrrolidone with at least one monomer that comprises a quaternary ammonium group, and salts of polyacrylic acids, polymethacrylic acids, poly(acrylic acid-co-acrolein), polyalginic acids, pectins, polyphosphoric acids, polyvinylphosphonic acids, polyvinylsulfonic acids, polyvinylsulfuric acids and poly(styrene-4-sulfonic acids).

6. The aqueous dispersion according to claim 3, wherein the polymer B is the cellulose derivatives selected from hydroxymethyl cellulose, hydroxyethyl cellulose, hydroxypropyl cellulose, hydroxypropylmethyl cellulose and carboxymethyl cellulose.

7. The aqueous dispersion according to claim 3, wherein the polymer B is the chitosan derivatives selected from chitosan pyroglutamate, chitosan lactate and hydroxypropyl chitosan.

8. The aqueous dispersion according to claim 1, wherein the total amount of polymer B is 1 to 50 wt %, based on the solids content.

9. The aqueous dispersion according to claim 1, wherein the dispersion is free of waxes and/or solvents.

10. A film substrate comprising the aqueous dispersion of claim 1 and a porous substrate.

11. The film substrate of claim 10, wherein the aqueous dispersion has a dry coating thickness of 3 to 40 g/m².

12. The film substrate of claim 10, which is a packaging.

13. A packaging for encasing an article comprising a substrate having two sides and a barrier coating produced by an aqueous dispersion coated on one side of the packaging that faces the article,
wherein the aqueous dispersion comprises:
(A) at least 50 wt %, based on the total solids content of the aqueous dispersion, of a polyvinyl acetate copolymer A; and
(B) a polymer B that contains hydroxyl and/or ionic groups;
wherein the copolymer A is different than polymer B.

14. The packaging according to claim 13, wherein the other side of the substrate is printed with a printed.

15. (canceled)

16. The film substrate of claim 10, wherein the porous substrate is a paper or cardboard.

17. A packaging comprising a plurality of substrates and an aqueous dispersion applied to at least one side of at least one substrate;
wherein at least one substrate is a paper or a cardboard;
wherein the aqueous dispersion comprises:
(A) at least 50 wt %, based on the total solids content of the aqueous dispersion, of a polyvinyl acetate copolymer A; and
(B) a polymer B that contains hydroxy and/or ionic groups;
wherein the copolymer A is different than polymer B.
